(19) United States
(12) Patent Application Publication
(10) Pub. No.: US 2008/0117954 A1
(43) Pub. Date: May 22, 2008

(54) Frequency-hopping analysis circuit of receiving apparatus in wireless transmission system

(76) Inventors: Yu-Min Chuang, Hsinchu City (TW); Fu-Min Yeh, Taoyuan City (TW); Juinn-Horng Deng, Pingjhen City (TW); You-Jung Shin, Lujhou City (TW); Gwo-Yang Wu, Zihguan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/601,763

(22) Filed: Nov. 20, 2006

(51) Int. Cl. H04B 1/713

(52) U.S. Cl. 375/137; 375/136; 375/E01.033

(57) ABSTRACT

The present invention relates to a frequency-hopping analysis circuit of a receiving apparatus in a wireless transmission system, which includes an RF receiving circuit, a detection circuit, and a matching module. The RF receiving circuit receives an RF signal according to an initial frequency-hopping sequence to produce a baseband signal. The detection circuit detects the signal strength of the baseband signal, and identifies the corresponding piconet group of the baseband signal according to the estimated strength. Then, the matching module matches a preamble of the baseband signal according to a plurality of piconets of the corresponding piconet group of the baseband signal, and gives the corresponding piconet of the baseband signal. Thereby, the corresponding frequency-hopping sequence of the baseband signal is given and is transmitted to the RF receiving circuit for replacing the initial frequency-hopping sequence.

### FIELD OF THE INVENTION

The present invention relates generally to a frequency-hopping analysis circuit, and particularly to a frequency-hopping analysis circuit of a receiving apparatus in a wireless transmission system.

### BACKGROUND OF THE INVENTION

Modern technologies make progresses day by day. Electronic products continuously weed through the old to bring forth the new, particularly for wireless mobile communication technologies. With the advancement of mobile communication technologies to date, technologies are about to enter 4 G from 2 G. Wireless wideband and the request of high data transmission rates have become the major topics of next-generation mobile communication systems.

However, because in wireless transmission channels, the influences of multi-path transmission and frequency-selective channels cause intersymbol interference (ISI), which makes the equalization technique in receiving apparatuses complicated. Comparatively, multi-carrier systems, such as the Orthogonal Frequency-Division Multiplexing (OFDM) technique, can resist effectively the influences of frequency-selective channels, thereby can simplify design of equalizers. Besides, because sub-carriers are orthogonal and overlap to each other, utilization of frequency spectrum is more efficient.

In addition, adding the frequency-hopping technique at the transmitter side of an OFDM system will increase interference-resisting capability by making the transmitter side less covered in spectrum by the interference source. Thereby, a corresponding frequency-hopping spread-spectrum decoding technique at the receiver side of the OFDM system is needed for extracting signals from the transmitter side. Nevertheless, synchronization has to be performed first while transmitting wireless communication data.

Accordingly, a novel frequency-hopping analysis circuit of a receiving apparatus in a wireless transmission system can achieve the purpose of synchronization in frequency hopping by extracting a radio-frequency (RF) signal according to a frequency-hopping sequence.

### SUMMARY

The purpose of the present invention is to provide a frequency-hopping analysis circuit of a receiving apparatus in a wireless transmission system. An RF receiving circuit achieves the purpose of synchronization in frequency hopping by receiving a RF signal transmitted by a transmission apparatus of the wireless transmission system according to a frequency-hopping sequence.

The frequency-hopping analysis circuit of a receiving apparatus in a wireless transmission system includes an RF receiving circuit, a detection circuit, and a matching module. The RF receiving circuit receives an RF signal transmitted by a transmission apparatus of the wireless transmission system according to an initial frequency-hopping sequence, and down-converts the RF signal to produce a baseband signal. The detection circuit detects the signal strength of the baseband signal, and identifies the corresponding piconet group of the baseband signal according to the estimated strength. Then, the matching module matches a preamble of the baseband signal according to a plurality of piconets of the corresponding piconet group of the baseband signal, and gives the corresponding piconet of the baseband signal. Thereby, the corresponding frequency-hopping sequence of the baseband signal is given and is transmitted to the RF receiving circuit for replacing the initial frequency-hopping sequence.

In addition, the detection circuit further includes a first delay unit, which receives the baseband signal and delays it by three clock pulses, a first operational module, which operates the baseband signals and the delayed baseband signal to produce a first operated signal, a second operational module, which operates the baseband signal to produce a second operated signal, a first comparator, which compares the first operated signal and the second operated signal to produce a first driving signal, and a first selection unit, which selects the corresponding piconet group of the baseband signal according to the first driving signal. Likewise, the detection circuit further includes a second delay unit, a third operational module, a fourth operational module, a third comparator, and a second selection unit. Thereby, the detection circuit can identify the corresponding piconet group of the baseband signal.

### BRIEF DESCRIPTION OF THE DRAWINGS

FIG. 1 shows a block diagram of a transmission system according to a preferred embodiment of the present invention;

FIG. 2A shows a table of frequency-hopping sequences of preambles according to a preferred embodiment of the present invention;

FIG. 2B shows a table of initial frequency-hopping sequences according to a preferred embodiment of the present invention;

FIG. 2C shows a schematic diagram of preambles of a received baseband signal according to a preferred embodiment of the present invention;

FIG. 3 shows a block diagram according to a preferred embodiment of the present invention;

FIG. 4 shows a detailed block diagram of a detection circuit according to a preferred embodiment of the present invention;

FIG. 5 shows a detailed block diagram of another detection circuit according to a preferred embodiment of the present invention; and

FIG. 6 shows a block diagram of a matching module according to a preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

The present invention uses, but not limited to, Multi-Band Orthogonal Frequency-Division Multiplexing Ultra Wide Band (MB-OFDM UWB) system as an example.

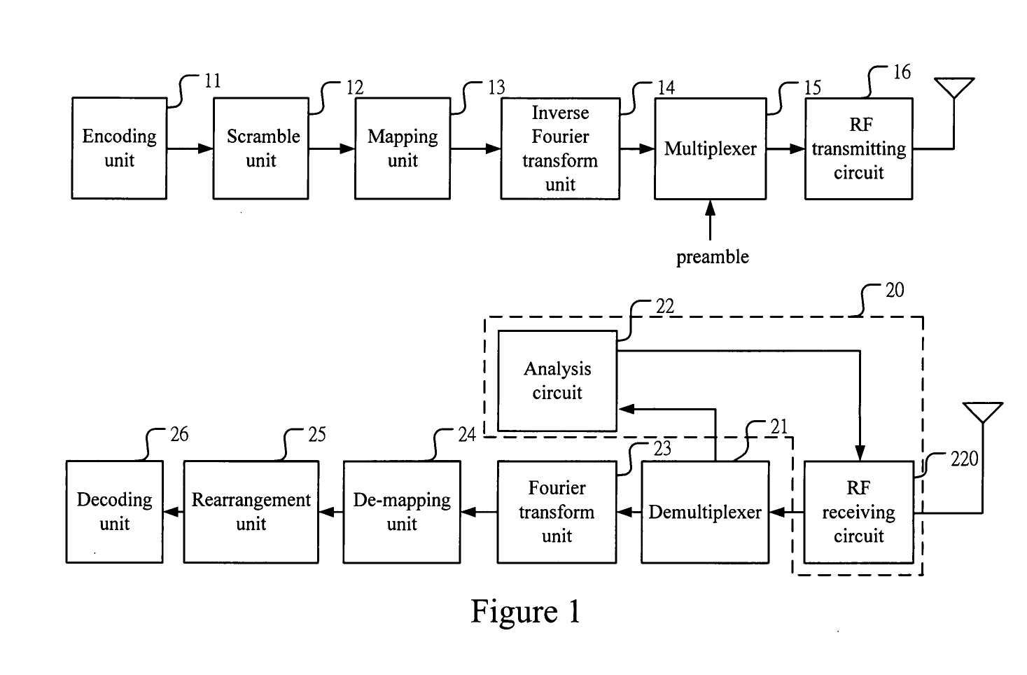

FIG. 1 shows a block diagram of a transmission system according to a preferred embodiment of the present invention. As shown in the figure, the transmission system includes a transmission apparatus and a receiving apparatus. The transmission apparatus includes an encoding unit 11, a scramble unit 12, a mapping unit 13, an inverse Fourier transform unit 14, a multiplexer 15, and a RF transmitting circuit 16. The encoding unit 11 receives an input signal and encodes the input signal. The scramble unit 12 scrambles the encoded input signal encoded by the encoding unit 11. The mapping unit 13 mirrors the scrambled signal scrambled by the scramble unit 12. The inverse Fourier transform unit 14 transforms the mirrored signal mirrored by the mapping unit 13 from frequency domain to time domain. The multiplexer 15 receives the time-domain signal and a preamble to produce a frequency-hopping sequence signal to the RF transmitting circuit 16. Thereby, the RF transmitting circuit can convert the frequency-hopping sequence signal to a RF signal, and then transmits the RF signal via a transmitting antenna.

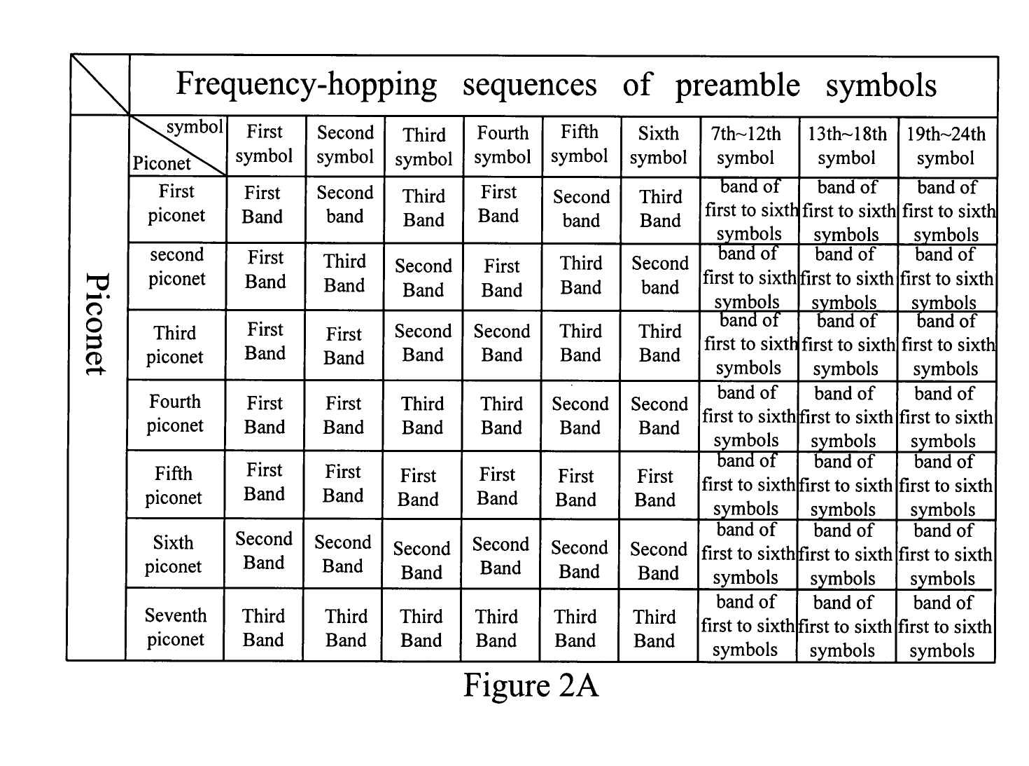

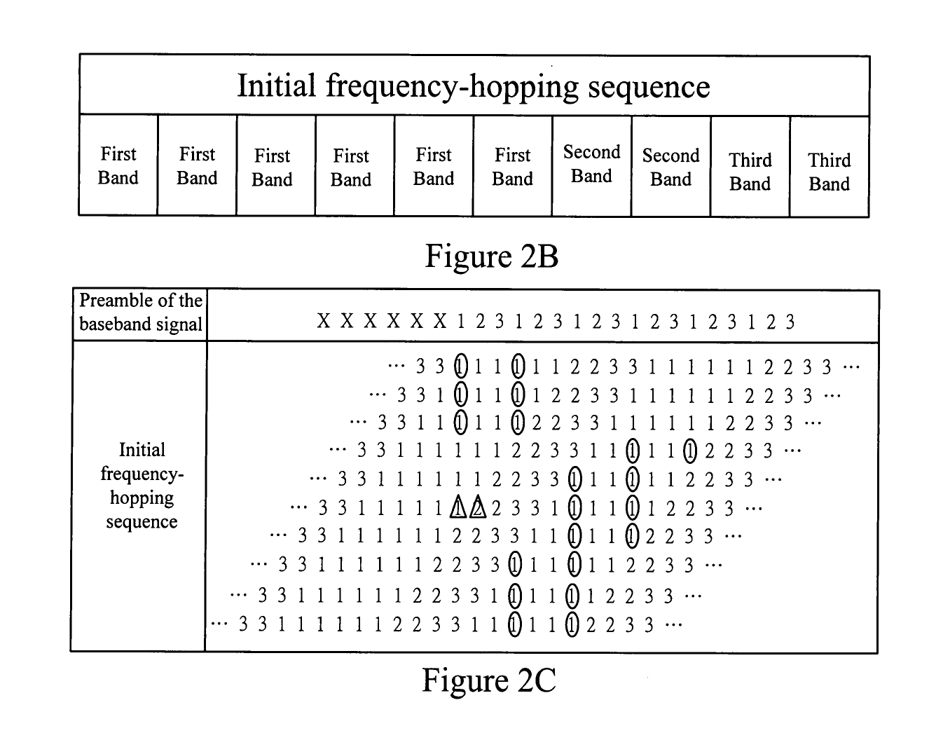

The preamble is a preamble symbol, which includes twenty-four identical symbols. The baseband signal further includes a header symbol and a payload symbol. The header symbol includes important parameters of effective symbols, for example, encoding rate and data length. Effective symbols are the real data transmitted by the transmitting apparatus. As shown in FIG. 2, between the transmitting apparatus and the receiving apparatus, there exists seven different piconets for selecting transmission packet data. Besides, each symbol in each piconet has different frequency-hopping method for transmitting data. Each frame includes twenty-four preamble symbols, and each of which uses a different frequency band for transmission. It can be concluded from the first piconet through the seventh piconet in FIG. 2 that the minimum period by which the symbols will appear in the same frequency band is as follows. The first piconet and the second piconet need three clock pulses. That is, it takes three symbol periods to return to the same frequency band. The third piconet to the seventh piconet need one clock pulse. That is to say, it takes one symbol period to return to the same frequency band.

The receiving apparatus includes a frequency-hopping analysis circuit 20, a demultiplexer 21, a Fourier transform unit 23, a de-mapping unit 24, a rearrangement unit 25, and a decoding unit 26. The frequency-hopping analysis circuit 20 further includes a RF receiving circuit 220 and an analysis circuit 22. The RF receiving circuit 20 receives an RF signal of the transmitting apparatus in the wireless transmission system and down-converts the RF signal to produce a baseband signal. The demultiplexer 21 receives the baseband signal and transmits the preamble of the baseband signal to the analysis circuit 22, and the header symbol and the payload symbol of the baseband signal to the Fourier transform unit 23, respectively. The analysis circuit 22 receives the baseband signal to produce a frequency-hopping sequence to the RF receiving circuit 220 for replacing the initial frequency-hopping sequence. Thereby, the RF receiving circuit 220 can receive RF signals according to the frequency-hopping sequence.

The Fourier transform unit 23 transforms the signals transmitted by the demultiplexer 21 to frequency-domain signals. The de-mapping unit 24 de-mirrors the frequency-domain signals transformed by the Fourier transform unit 23 and transmits them to the rearrangement unit 25. The rearrangement unit 25 rearranges the signals processed by the de-mapping unit 24. Then the decoding unit 26 decodes the signals processed by the rearrangement unit 25.

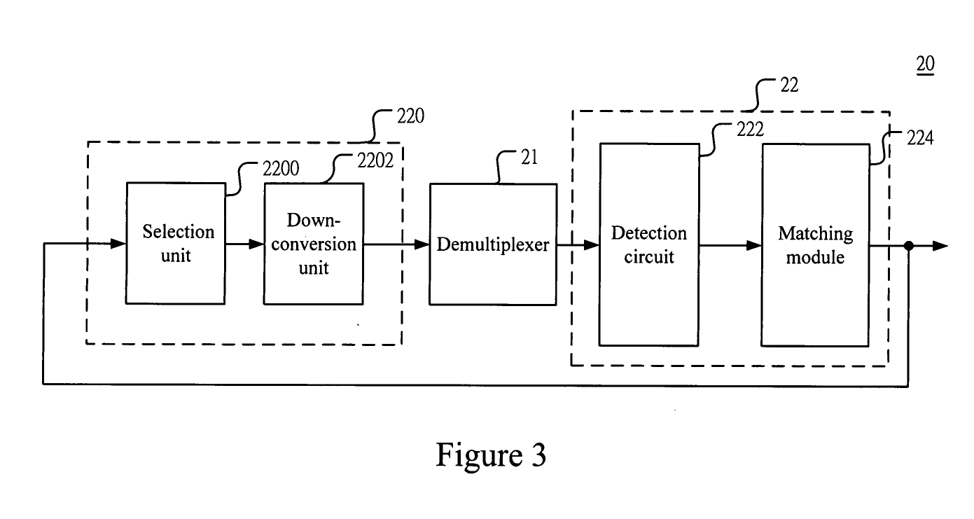

It can be known from above that the frequency-hopping analysis circuit 20 according to the present invention receives the RF signal and analyzes the RF signal for giving the frequency band the transmitting apparatus used for transmitting the RF signal. Thereby, the purpose of synchronization in frequency hopping is achieved. FIG. 3 shows a block diagram according to a preferred embodiment of the present invention. As shown in the figure, the frequency-hopping analysis circuit 20 of the receiving apparatus in the wireless transmission according to the present invention includes an RF receiving circuit 220, a demultiplexer 21, and an analysis circuit 22. The RF receiving circuit 220 receives an RF signal of the transmitting apparatus in the wireless transmission system and down-converts the RF signal to produce a baseband signal. Thereby, the characteristic of repeated appearance of periods of the piconets with different baseband signals can be reserved for convenience in processing by the analysis circuit 22. In order to extract all possible types of the seven piconets, and to make sure the characteristic of repeated appearance of periods is satisfied, the initial frequency-hopping sequence is designed as the sequence shown in FIG. 2B.

In addition, as shown in FIG. 2C, if the piconet of received baseband signal is the first piconet (X represents noise, and 1 to 3 represent frequency band). After the RF receiving circuit 220 receives the baseband signal according to the initial frequency-hopping sequence, if the frequency band is the same, the baseband signal will be transmitted to the detection circuit 222 for processing, as the circles shown in FIG. 2C. If the frequency band is not the same, the noises in the baseband signal will be filtered by a filter, and will be transmitted to post-circuits for processing. Thereby, as shown in FIG. 2C, after receiving the baseband signal by the RF receiving circuit 220, the characteristic of repeated appearance for every three clock pulses of the first piconet is still reserved. Hence, the analysis circuit 22 can then identify two different piconet groups. The demultiplexer 21 receives the baseband signal, and transmits the preamble of the baseband signal to the analysis circuit 22. The analysis further includes a detection circuit 222 and a matching module 224. The detection circuit 222 detects the signal strength of the baseband signal, and identifies the corresponding piconet group of the baseband signal according to the estimated strength. Then, the matching module 224 matches a preamble of the baseband signal according to a plurality of piconets of the corresponding piconet group of the baseband signal, and gives the corresponding piconet of the baseband signal. Thereby, the corresponding frequency-hopping sequence of the baseband signal is given and is transmitted to the RF receiving circuit 220 for replacing the initial frequency-hopping sequence. Hence, the purpose of synchronization in frequency hopping is achieved by the RF receiving circuit 220.

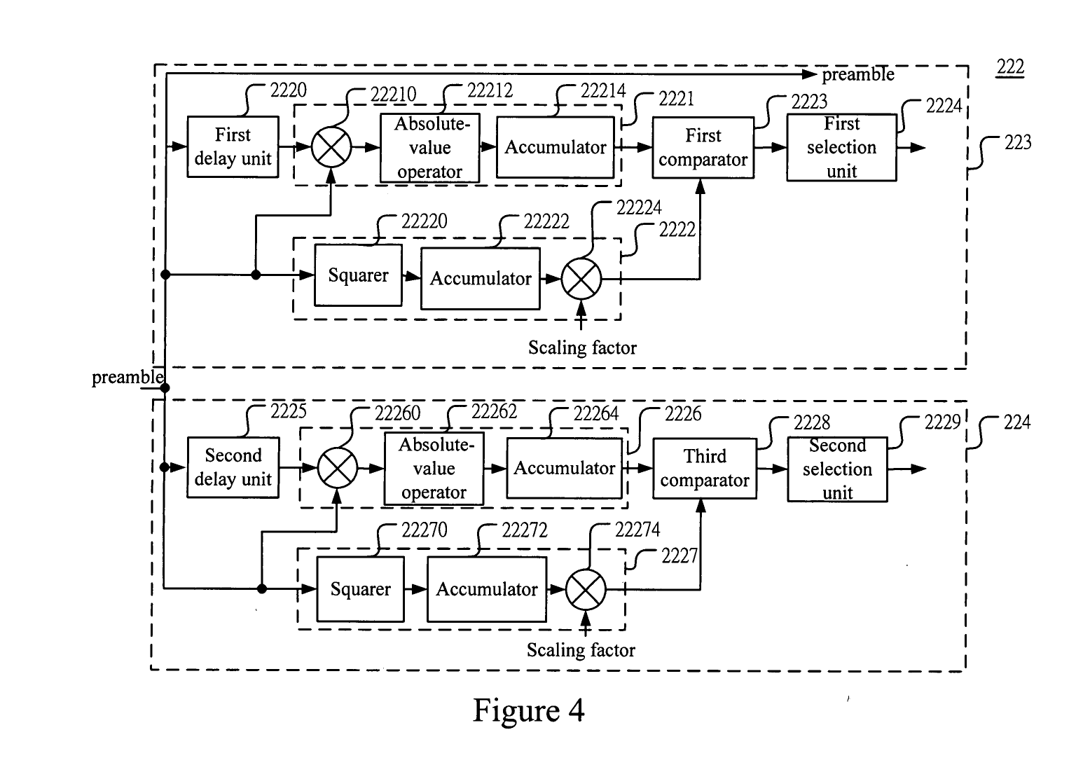

FIG. 4 shows a detailed block diagram of a detection circuit according to a preferred embodiment of the present invention. As shown in the figure, the main purpose of the detection circuit 222 is to identify that the unknown piconet adopts a first group or a second group, where the first group is the group including the first piconet and the second piconet, while the second group is the group including the third piconet to the seventh piconet. The detection circuit 222 includes a first circuit 223 and a second circuit 224. The first circuit 223 is used for identifying the first group, while the second circuit 224 is used for identifying the second group. The first circuit 223 includes a first delay unit 2220, a first operational module 2221, a second operational module 2222, a first comparator 2223, and a first selection unit 2224. The first delay unit 2220 receives the baseband signal and delays it by three clock pulses, that is, by three symbols. The first operational module 2221 operates the baseband signals and the delayed baseband signal to produce a first operated signal. The second operational module 2222 operates the baseband signal to produce a second operated signal. The first comparator 2223 compares the first operated signal and the second operated signal. When the strength of the first operated signal is greater than that of the second operated signal, it means that the received baseband signal by the detection circuit 222 belongs to the piconet of the fist group. And then a first driving signal is produced. The first selection unit 2224 selects the corresponding piconet group of the baseband signal according to the first driving signal.

Moreover, the first operational module 2221 further includes a multiplier 22210, an absolute-value operator 22212, and an accumulator 22214. The multiplier 22210 multiplies the baseband signal by the delayed baseband signal to produce a first signal. The absolute-value operator 22212 take the absolute value of the first signal. The accumulator 22214 accumulates the operated first signal processed by the absolute-value operator 22212 and produces a first operated signal. Besides, the second operational module 2222 includes a squarer 22220, an accumulator 22222, and a multiplier 22224. The squarer 22220 squares the baseband signal. The accumulator 22222 accumulates the signal operated by the squarer 22220 to produce a signal, which is then multiplied by the multiplier 22224 by a scaling factor to produce the second operated signal, where the scaling factor can be between 0.4 and 0.5. Similarly, the structures of the third operational module 2226 and the first operational module 2221 are the same, and the structures of the fourth operational module 2227 and the second operational module 2222 are the same. Thus, they will not be described further.

Likewise, the second circuit 224 includes a second delay unit 2225, a third operational module 2226, a fourth operational module 2227, a third comparator 2228, and a second selection unit 2229, and is used for identifying the piconets of the second group.

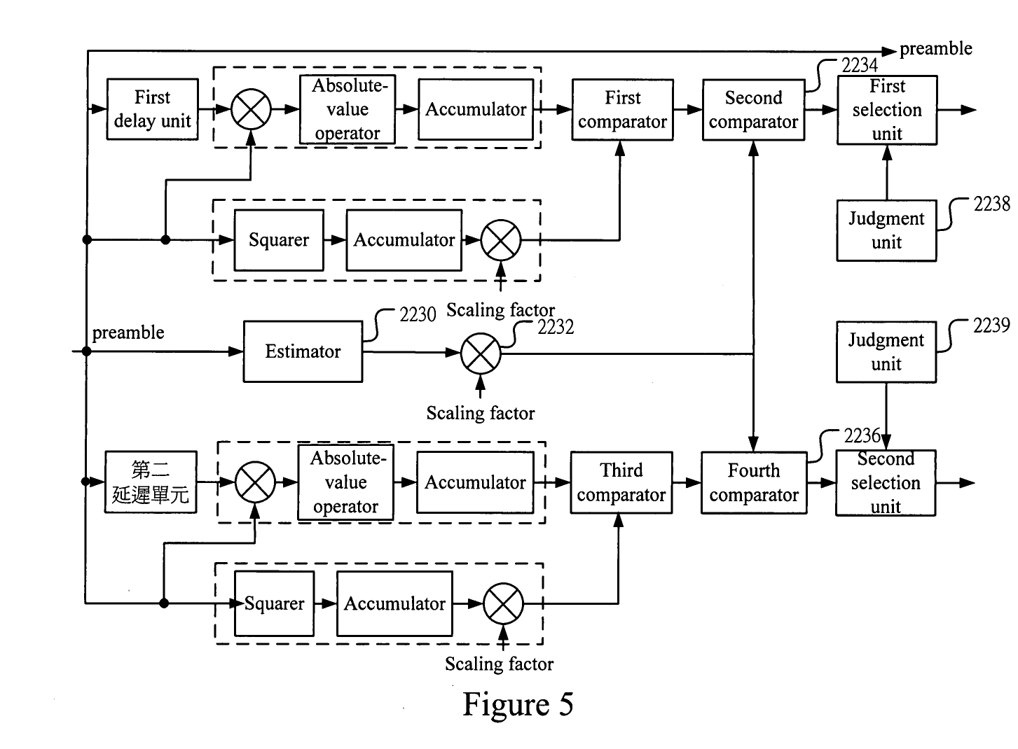

In addition, FIG. 5 shows a detailed block diagram of another detection circuit according to a preferred embodiment of the present invention. As shown in the figure, the differences between FIG. 4 and FIG. 5 are that in FIG. 5, there exists an estimator 2230 to accompany the second comparator 2234 and the fourth comparator 2236, and there exists judgment units 2238, 2239. The main purpose thereof is to avoid false move of the detection unit 222. The estimator 2230 estimates the strength of noises to produce an estimation signal, which is multiplied by a multiplier 2232 by a scaling factor and then is transmitted to the second comparator 2234 and the fourth comparator 2236. The second comparator 2234 compares the first operated signal and the estimation signal according to the first driving signal for driving the first selection unit 2224 to select the corresponding piconet group of the baseband signal, that is, the first group. Thereby, false moves by the detection unit 222 when it is not receiving baseband signal and is under noisy environment can be prevented. Besides, the scaling factor is between 3 and 4. Likewise, when the estimation signal is transmitted to the fourth comparator 2236, it compares the third operated signal and the estimation signal for driving the second selection unit 2229 to select the corresponding piconet group of the baseband signal, that is, the second group.

The judgment unit 2238 judges if the baseband signal and the baseband signal delayed by three clock pulses occupying the same frequency band for producing a judgment signal to the first selection unit 2224 to drive the first selection unit 2224 select the corresponding piconet of the baseband signal, that is, the first group. Similarly, the judgment unit 2239 judges if the baseband signal and the baseband signal delayed by one clock pulse occupying the same frequency band for producing a judgment signal to the second selection unit 2229 to drive the second selection unit 2229 select the corresponding piconet of the baseband signal, that is, the second group. Thereby, false move by the detection unit 222 caused by judging that the strength of the delayed signal given by multiplying received baseband signals of different frequency bands via the delay units 2220, 2225 is greater than the strength of the signal without delay can be avoided (as the A shown in FIG. 2C).

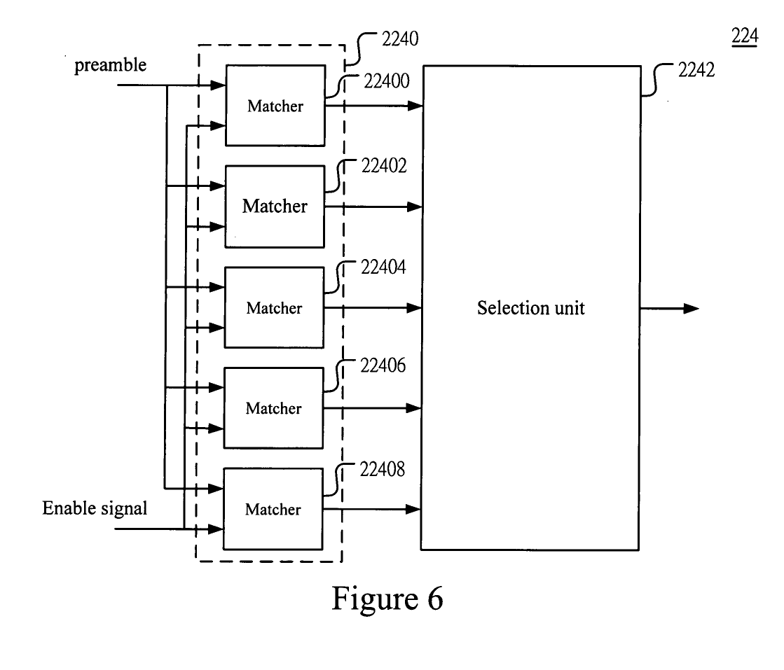

FIG. 6 shows a block diagram of a matching module according to a preferred embodiment of the present invention. As shown in the figure, the matching module 224 includes a plurality of matchers 2240 and a selection unit 2242. The plurality of matchers 2240 is driven to match the preamble of the baseband signal according to a plurality of piconets of the corresponding piconet group of the baseband signal. That is, when the detection circuit 222 transmits an enable signal to the matching module 224, the plurality of matchers 2240 matches the preamble of the baseband signal. One of matchers will transmit a peak value signal to the selection unit 2242, and the others will relatively transmit noises to the selection unit 2242. The selection unit 2242 gives the corresponding frequency-hopping sequence according to the preamble, and transmits it to the RF receiving circuit 220 for replacing the initial frequency-hopping sequence. Thereby, the RF receiving circuit receives data according to the frequency-hopping sequence.

To sum up, the frequency-hopping analysis circuit of a receiving apparatus in a wireless transmission system according to the present invention includes an RF receiving circuit, a detection circuit, and a matching module. The RF receiving circuit receives an RF signal according to an initial frequency-hopping sequence. The detection circuit detects the signal strength of the baseband signal, and identifies the corresponding piconet group of the baseband signal. Then, the matching module matches a preamble of the baseband signal, and gives the corresponding piconet of the baseband signal. Thereby, the corresponding frequency-hopping sequence of the baseband signal is transmitted to the RF receiving circuit for replacing the initial frequency-hopping sequence.

Accordingly, the present invention conforms to the legal requirements owing to its novelty, unobviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A frequency-hopping analysis circuit of a receiving apparatus in a wireless transmission system, comprising:
a radio-frequency (RF) receiving circuit, receiving an RF signal transmitted by a transmission apparatus of the wireless transmission system according to an initial frequency-hopping sequence, and down-converting the RF signal to produce a baseband signal
a detection circuit, detecting the signal strength of the baseband signal, and identifying the corresponding piconet group of the baseband signal according to the estimated strength; and
a matching module, matching a preamble of the baseband signal according to a plurality of piconets of the corresponding piconet group of the baseband signal, giving the corresponding piconet of the baseband signal, and giving the corresponding frequency-hopping sequence of the baseband signal, which is transmitted to the RF receiving circuit for replacing the initial frequency-hopping sequence.

2. The frequency-hopping analysis circuit of claim 1, wherein the RF receiving circuit further comprises:
a selection unit, receiving the RF signal of the transmitting apparatus according to the initial frequency-hopping sequence or the frequency-hopping sequence; and
a down-converting circuit, down-converting the RF signal to produce the baseband signal.

3. The frequency-hopping analysis circuit of claim 1, wherein the detection circuit further comprises:
a first delay unit, receiving the baseband signal and delaying the baseband signal by three clock pulses;
a first operational module, operating the baseband signal and the delayed baseband signal to produce a first operated signal;
a second operational module, operating the baseband signal to produce a second operated signal;
a first comparator, comparing the first operated signal and the second operated signal to produce a first driving signal; and
a first selection unit, selecting the corresponding piconet group of the baseband signal according to the first driving signal.

4. The frequency-hopping analysis circuit of claim 3, wherein the detection circuit further comprises:
an estimator, estimating the strength of noises to produce an estimation signal; and
a second comparator, comparing the first operated signal and the estimation signal for driving the first selection unit select the corresponding piconet group of the baseband signal according to the first driving signal.

5. The frequency-hopping analysis circuit of claim 4, wherein the detection circuit further comprises a multiplier, multiplying the estimation signal by a scaling factor and transmitting to the second comparator.

6. The frequency-hopping analysis circuit of claim 5, wherein the scaling factor is between 3 and 4.

7. The frequency-hopping analysis circuit of claim 3, wherein the detection circuit further comprises a judgment unit, judging if the baseband signal and the baseband signal delayed by three clock pulses occupying the same frequency band for producing a judgment signal to the first selection unit to drive the first selection unit select the corresponding piconet of the baseband signal.

8. The frequency-hopping analysis circuit of claim 3, wherein the first operational module further comprises:
a multiplier, multiplying the baseband signal by the delayed baseband signal to produce a first signal;
an absolute-value operator, taking the absolute value of the first signal; and
an accumulator, accumulating the operated first signal operated by the absolute-value operator to produce the first operated signal.

9. The frequency-hopping analysis circuit of claim 3, wherein the second operational module further comprises:
a squarer, squaring the baseband signal; and
an accumulator, accumulating the signal operated by the squarer to produce the second operated signal.

10. The frequency-hopping analysis circuit of claim 9, wherein the second operational module further comprises a multiplier, multiplying the accumulated signal operated by the accumulator by a scaling factor to produce the second operated signal.

11. The frequency-hopping analysis circuit of claim 10, wherein the scaling factor is between 0.4 and 0.5.

12. The frequency-hopping analysis circuit of claim 1, wherein the detection circuit further comprises:
a second delay unit, receiving the baseband signal and delaying the baseband signal by one clock pulse;
a third operational module, operating the baseband signal and the delayed baseband signal to produce a third operated signal;
a fourth operational module, operating the baseband signal to produce a fourth operated signal;
a third comparator, comparing the third operated signal and the fourth operated signal to produce a second driving signal; and
a second selection unit, selecting the corresponding piconet group of the baseband signal according to the second driving signal.

13. The frequency-hopping analysis circuit of claim 12, wherein the detection circuit further comprises:
an estimator, estimating the strength of noises to produce an estimation signal; and
a fourth comparator, comparing the third operated signal and the estimation signal for driving the second selection unit select the corresponding piconet group of the baseband signal according to the second driving signal.

14. The frequency-hopping analysis circuit of claim 13, wherein the detection circuit further comprises a multiplier, multiplying the estimation signal by a scaling factor and transmitting to the fourth comparator.

15. The frequency-hopping analysis circuit of claim 14, wherein the scaling factor is between 3 and 4.

16. The frequency-hopping analysis circuit of claim 12, wherein the detection circuit further comprises a judgment unit, judging if the baseband signal and the baseband signal delayed by one clock pulse occupying the same frequency band for producing a judgment signal to the second selection unit to drive the second selection unit select the corresponding piconet of the baseband signal.

17. The frequency-hopping analysis circuit of claim 12, wherein the third operational module further comprises:
a multiplier, multiplying the baseband signal by the delayed baseband signal to produce a second signal;
an absolute-value operator, taking the absolute value of the second signal; and
an accumulator, accumulating the operated second signal operated by the absolute-value operator to produce the third operated signal.

18. The frequency-hopping analysis circuit of claim 12, wherein the fourth operational module further comprises:
a squarer, squaring the baseband signal; and
an accumulator, accumulating the signal operated by the squarer to produce the fourth operated signal.

19. The frequency-hopping analysis circuit of claim 18, wherein the fourth operational module further comprises a multiplier, multiplying the accumulated signal operated by the accumulator by a scaling factor to produce the fourth operated signal.

20. The frequency-hopping analysis circuit of claim 19, wherein the scaling factor is between 0.4 and 0.5.

21. The frequency-hopping analysis circuit of claim 1, wherein the matching module further comprises:
a plurality of matchers, being driven to match the preamble of the baseband signal according to the plurality of piconets of the corresponding piconet group of the baseband signal; and
a selection unit, giving the corresponding frequency-hopping sequence according to the preamble, and transmitting it to the RF receiving circuit for replacing the initial frequency-hopping sequence.

22. The frequency-hopping analysis circuit of claim 1 is applied in Multi-Band Orthogonal Frequency-Division Multiplexing Ultra Wide Band (MB-OFDM UWB).

23. The frequency-hopping analysis circuit of claim 1, wherein the estimator can be a power estimator.
